(19) United States
(12) Patent Application Publication
(10) Pub. No.: US 2010/0094674 A1
(43) Pub. Date: Apr. 15, 2010

(54) Supply Chain Management Systems and Methods

(76) Inventors: Michael Marriner, Laguna Beach, CA (US); Alex Nielsen, Rexburg, ID (US); Roy Hodges, Washington, DC (US)

Correspondence Address: FISH & ASSOCIATES, PC;ROBERT D. FISH, 2603 Main Street, Suite 1000, Irvine, CA, 92614-6232, US

(21) Appl. No.: 12/577,660

(22) Filed: Oct. 12, 2009

Related U.S. Application Data
(60) Provisional application No. 61/105,308, filed on Oct. 14, 2008.
(60) Provisional application No. 61/105,310, filed on Oct. 14, 2008.
(60) Provisional application No. 61/105,315, filed on Oct. 14, 2008.
(60) Provisional application No. 61/105,318, filed on Oct. 14, 2008.
(60) Provisional application No. 61/105,321, filed on Oct. 14, 2008.
(60) Provisional application No. 61/105,327, filed on Oct. 14, 2008.
(60) Provisional application No. 61/105,333, filed on Oct. 14, 2008.
(60) Provisional application No. 61/105,344, filed on Oct. 14, 2008.

(51) Int. Cl. G06Q 10/00; G06Q 50/00; G06F 17/30

(52) U.S. Cl. 705/7; 705/28; 707/622; 707/E17.006

(57) ABSTRACT

Supply chain management (SCM) systems and methods are presented. In SCM ecosystems having multiple independent trading partners that can functions as peers, the trading partners likely lack a “single version of truth” with respect to retail data formats or transactions. The partners can utilize database connectors to interact with other peer partners by converting the partner's retail data from proprietary formats to a common transaction format understood by all connectors or by an SCM application stack constructed from SCM modules. The connectors can use a registry server to discover other connectors capable participating in a requested transaction relationship. SCM modules can be configured to support a transaction relationship according to the transaction relationships available to the peers' connectors.

This application claims the benefit of priority to U.S. provisional applications having Ser. Nos. 61/105,308, 61/105,310, 61/105,315, 61/105,318, 61/105,321, 61/105,327, 61/105,333, and 61/105,344 all filed Oct. 14, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is distributed application technologies.

### BACKGROUND

In the retail industry, many independent retailers find it difficult to compete against larger chain stores. Large chain stores enjoy an economy of scale by leveraging their extensive buying power to purchase and sell products at low costs. Unfortunately, independent retailers lack such abilities. Additionally, product suppliers (e.g., manufacturers, brand name suppliers, etc . . . ) can be at risk due to the practices of the large chain stores. For example, a supplier's revenue from a large retail chain could represent a significant portion of the total supplier's revenue, often times greater than 60%. Even if the revenue from the chain store is large, the revenue could easily have little or no profit due the pricing pressure applied by the chain stores on the supplier. Interestingly, the large chain stores find themselves at risk because their practices drive out the independent retailers and can cause suppliers to fail. The large chain stores, unable to innovate new and interesting products are discovering that they need the diverse, small suppliers to innovate new products. The suppliers require the small or independent retailers to whom they wish to sell their products in order to generate revenue to offset the risk of losing the revenue from the large chain. The result is a precarious retail ecosystem where the independent retailers, product suppliers, vendors, service providers, or large chains stores all depend on each other.

Large retail chain stores or large suppliers reduce their costs within the ecosystem through high-end software systems designed to integrate point-of-sales (PoS) systems, inventory management, product forecasting, customer relationship management, or supply replenishment. Such supply chain management (SCM) systems are often proprietary or are extremely expensive placing them out of the reach of smaller, independent trading partners. Independents suffer further in the ecosystem because they are unable to fully leverage the capabilities of an effective SCM solution.

SCM solutions that are available to independent trading partners are not only expensive, but also have a high cost to maintain. For example, an independent can purchase a software package to integrate their PoS with their inventory system; however, the independent must also pay an employee to enter data into the SCM solution. An independent soon discovers that the costs and difficulty to keep the SCM solution running far exceeds the benefits. Furthermore, such solutions fail to integrate with other SCM solutions used by other independents or even with the large retailers or suppliers.

Retail ecosystems require an SCM solution that can allow independent retailers, distributors, or product suppliers to fully participate in the ecosystem on a level playing field with the large chain stores or suppliers. A better SCM solution is required to allow independent trading partners to function as peers, possibly taking on different roles or responsibilities, with respect to each other in the ecosystem while allowing the independent trading partners to retain the simplicity of their own proprietary retail databases or retail data formats. Such an approach is especially desirable in an environment where relationships among trading peers can change dynamically.

Others have put forth a great deal of effort to provide various forms of SCM solutions. One example includes U.S. Pat. No. 6,954,736 to Menninger et al. titled “System, Method and Computer Program Product for Order Confirmation in a Supply Chain Management Framework” filed Mar. 23, 2001. Menninger's expansive disclosure provides for receiving confirmation of an order though an alert, but provides little support for an independent trading partner that could have multiple roles or responsibilities within an SCM ecosystem.

Other examples of SCM related technologies include those disclosed in the following references:
U.S. Pat. No. 6,996,538 to Lucas titled “Inventory Control System and Methods” filed Mar. 7, 2001, provides for a third party to monitor a company's inventory.
U.S. Pat. No. 7,363,249 to Boesjes titled “Multiply-Integrated System for Product Inventory, Sales, and Distribution” filed Jun. 4, 2001, also provides for monitoring inventory as well as placing orders and shipping products.
U.S. Pat. No. 7,403,975 to Berkery et al. titled “Design for Highly-Scalable Distributed Replenishment Planning Algorithm” filed Nov. 10, 2003, provides parallel processing of supply chain management problems.
U.S. patent application publication 2008/0168008 to Brown titled “Exchanging Retail Pricing Information” filed Jan. 8, 2007, describes sharing pricing information among retailers.
U.S. patent application publication 2004/0153359 to Ho et al. titled “Integrated Supply Chain Management” filed Jan. 31, 2003 discusses a centralized supply chain management system comprising various SCM support modules.
International patent application publication WO 2000/54204 to Groult et al. titled “Internet-Based Exchange for Products and Services” filed Mar. 10, 2000, also discusses a transaction system between vendors and buyers via a bidding process.

The above references and other known art fail to take into account the dynamic nature of relationships among trading partner peers with respect to an SCM transaction in an SCM ecosystem, especially where each of the trading partner peers has a local, proprietary database.

Still others have minimally addressed some aspects of relationships among trading partner peers. For example, U.S. patent application publication 2002/0095457 to Sharma et al. titled “System and Methods for Sharing and Viewing Supply Chain Information” filed Oct. 29, 2001, describes a system where supply chain information is shared among users and where the supply chain information is secured according to the type of data. Although Sharma provides for information sharing in an SCM ecosystem, Sharma also fails to address the dynamic changing relationships among trading partner peers.

U.S. Pat. No. 7,376,600 to Wadawadigi et al. titled “Intelligent Fulfillment Agents” filed on Apr. 10, 2002, has a somewhat larger appreciation of relationships among members of a fulfillment system. Wadawadigi discusses modeling relationships among members in a value chain. However, Wadawadigi fails to take into account an actual implementation of a transaction relationship in a dynamic, uncertain environment were a trading partner might or might not be present.

Traditional approaches to SCM solutions includes synchronizing all data centrally, which imposes severe data synchronization requirements on the ecosystem members, especially small retailers, to ensure they have the most up to date data. However, in a decentralized SCM solution each member can maintain its own data locally, while allowing remote members to access the data. The members of the ecosystem essentially form a circle of trust with respect to data integrity where each member presents a single unified view of the data to the other members. Such an approach eliminates the synchronization requirements while enabling efficient communication among members.

The industry appears to lack an appreciation that many of the above issues can be readily resolved by providing independent trading partners with database connectors that are configured to allow the trading partners to function as peers capable of taking on different roles within a transaction relationship in an SCM ecosystem. Information about the various possible relationships in which the connectors can participate can be stored in a registry database. When a peer requires a transaction, a transaction relationship can be established based on the registration information by configuring one or more SCM modules to support a transaction according to the requested transaction relationship. Such an approach allows the partners to retain control over their data and to retain their independence from other members of the ecosystem, while also supporting each other.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Thus, there is still a need for distributed supply chain management solutions.

### SUMMARY OF THE INVENTION

The inventive subject matter provides apparatus, systems and methods in which a Supply Chain Management (SCM) system can be provided where trading partners of a value chain can retain proprietary data formats while conducting transactions with other trading partners. One aspect of the inventive subject matter includes an SCM system where trading partners of the value chain can operate as peers and can take on different roles with respect to each other, if desired, in one or more transaction relationships. The trading partners of the chain can each have a database storing retail data (e.g., inventory data, sales data, marketing data, etc.) in their own proprietary format. A partner can enhance their databases with a database connector configured to convert the retail data from the proprietary format to a common transaction format, which can then be used to exchange transaction data among peer partners to fulfill an SCM transaction.

Contemplated SCM systems can also comprises a registry server storing database connector registration information that indicates roles, responsibilities, permissions, functions, or other data relating to how a connector can function within the system. The registration information can also include one or more available transaction relationships, in which the connector can participate. When a trading peer wishes to conduct a transaction with other peer members, a plurality of SCM modules can be configured according a requested transaction relationship in support of the transaction. The requested transaction relationship can be constructed from those available to the database connectors involved in the transaction. The peer trading partners can conduct the transaction by exchanging their retail data among their respective database connectors and with the SCM modules. In some embodiments the SCM modules configured or arranged to provide a vendor management inventory (VMI) service, a customer relationship management (CRM) service, or other types of applications in support of the value chain. It is also contemplated that the functionality provided by the SCM modules or the requested transaction relationship can be restricted based on a one or more database connector's permitted access levels.

One should note that the contemplated system can function in a peer-to-peer manner where database connectors can exchange retail data directly with each other. In some embodiments, a trading partner's database connector can include the SCM modules, which is expected to reduce latency time when exchanging data among peers in some applications.

Another aspect of the inventive subject matter includes methods of providing an SCM system. One step of the method can include configuring trading partner databases with the contemplated database connecters described in greater detail below. Additionally, a database connector registry can be provided that stores registry information for the trading partner's database connectors or other peers within the system. The method can also include configuring SCM modules to fulfill a transaction among the trading partners by constructing a requested transaction relationship from available transaction relationships of the database connectors. The method can further include exchanging retail data among the connectors or modules using a common transaction data format.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic overview of a supply chain management system.

FIG. 2 is a schematic overview of a supply chain management server comprising SCM modules and a database connector registry.

FIG. 3 is a schematic overview of a supply chain management system where servers operated by trading partners comprise SCM modules.

FIG. 4A is a schematic overview of a supply chain management system having an analysis engine.

FIG. 4B is a schematic of a trading partner interface rendering an analytics dashboard presenting transaction metrics.

FIG. 5 is a schematic overview of a method for providing a supply chain management system.

### DETAILED DESCRIPTION

Throughout the following discussion, numerous references will be made regarding servers, services, interfaces, modules, platforms, or other systems formed from computing devices. It should be appreciated that the use of such terms is deemed to represent one or more computing devices having at least one processor configured to execute software instructions stored on a computer readable media. For example, a server can include one or more computer operating as a web server, database server, a server farm, or other type of computer server in a manner to fulfill described roles, responsibilities, or functions. One should appreciate that the deployment of the disclosed subject matter provides a platform that reduces an amount of processing time for managing a value chain among peer members of the chain, or can increase computing capabilities to address SCM applications.

One should appreciate that although aspects of the inventive subject matter are presented within the context of an SCM system, it is also contemplated that the disclosed techniques can also be applied to broader markets beyond SCM. The disclosed techniques can also be applied distributed applications, or to distributed computing concepts in general, cloud computing for example.

### Overview of an SCM System

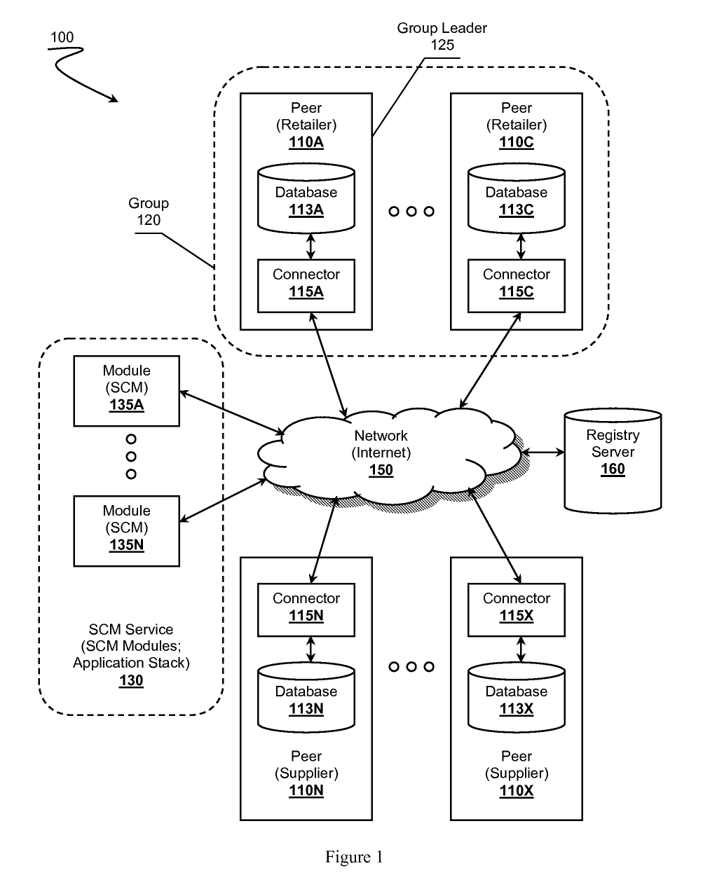

In FIG. 1, an SCM system 100 can comprise multiple trading partner peers that interact with each other. Trading partner peers can include peers 110A through 110X, collectively referred to as peers 110, that can take on one or more different roles in one or more transaction relationships. It is contemplated that trading partner peers 110 can include retailers, suppliers, distributors, vendors, service providers, or other entities that could participate in a value chain. Although the following presentation discusses the subject matter from the perspective of retailers and suppliers, it should be appreciated that the subject matter can be equally applied to other possible types of trading partners, or roles within a transaction relationship.

In embodiments, where trading partner peers 110 operate as unaffiliated or independent peers in SCM ecosystem 100, it is likely that each has their own database 113 storing retail data in their own proprietary format. For example, retailer peer 110A stores its retail data in database 113A as would peers 110C through 110X store their retail data in databases 113C through 113X, collectively referred to as databases 113. One should note that although FIG. 1 illustrates a single database per peer, it is contemplated that peers 110 could have zero databases, one database, or multiple databases as desired to fit a target application. When a peer 110 lacks a database, its connector 115 could be considered a data source or data sink. Databases 113 are considered to store retail data in the proprietary formats of their respective peers simply because peers 110 likely remain independent or unaffiliated from each other. For example, a small art boutique might simply store retail data in a small Access™ database while an art supply distributor might store their retail data in a PostgreSQL database using a completely different format.

The retail data stored in databases can include various desirable data that could pertain to an SCM transaction. The retail data could include inventory data, services information, product information, shipping data, SKUs, clientele data, supplier data, vendor data, distributor data, transaction metrics, marketing data, reports, or other data that could relate to an SCM transaction. Retail data is considered to include raw data from the databases as well as processed data, possibly from an SCM transaction application. Processed data can include retail data that has been converted or reduced, or can include newly generated data.

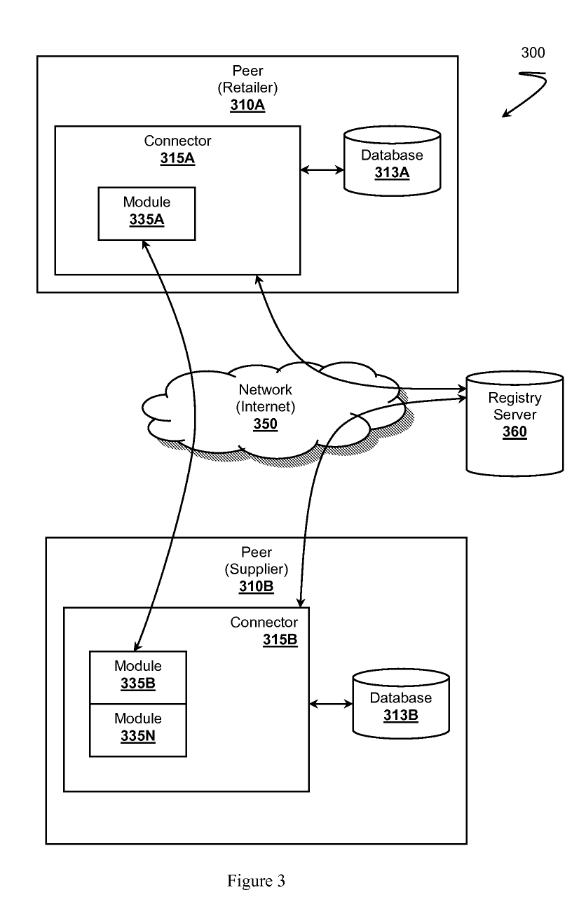

In a preferred embodiment, peers 110 can configure their respective databases with one or more database connectors 115A through 115X, collectively referred to as database connectors 115. Database connectors 115 provide several advantageous features. One feature includes the ability to convert retail data from a peer's proprietary data format to a common transaction format, through which the peers can exchange transaction data with each other or an SCM transaction application. Another feature includes providing peers 110 connectivity to each other's databases 113 over network 150, preferably the Internet. Connectors 115 can share data from databases 113 in support of a transaction relationship, subject to permissions or other form of access level. It is also contemplated the connectors 115 could also comprise one or more SCM modules 135A through 135N, referred to as SCM modules 135, as discussed below with respect to FIG. 3.

It is contemplated that the common transaction format used to exchange data among peers of the system could be governed by an industry standard. In such embodiments, connectors 115 could be certified by a regulatory body, either government or industry, as adhering to the data exchange industry standard. A certification could be represented by a VeriSign™ certificate, or public or private assigned keys, which could be stored on registry server 160. Connector registry server 160 can manage the validation of certificates as connectors 115 interact with each other or an SCM application. Preferred certifications can indicate compliance with industry-sanctioned standards relating to collaborative planning, forecasting and replenishment (CPFR), possibly corresponding to the standards offered by the Voluntary Interindustry Commerce Solutions Association (VICS) (http://www.vics.org) or those supported by the Craft & Hobby Associate (http://www.insightu.org/hobby/index.htm). Certifications can also indicate compliance with a common transaction format for retail data exchange.

Connectors 115 can comprise a mapping facility that includes one or more rules for converting proprietary retail data from a first format to a second format and back again. As retail data flows to and from a peer 110, its connector 115 converts to and from the respective formats as required. The mapping facility can include various types of mappings from one format to another including a one-to-one mapping, one-to-many mapping, many-to-one mapping, or a many-to-many mapping. In some embodiments, the mapping facility can include one or more programmatic modules (e.g., software instructions stored in a computer readable memory capable of being execute on a processor) that include instructions or functions that operate on the retail data to provide proper format conversion. The mapping facility could use one or more look-up tables, for example. One aspect of the inventive subject matter is considered to include providing peers 110 access to one or more utilities that allow peers 110, or other users, to construct a proper mapping facility for connectors 115.

Database connectors 115 can also include one or more networking interfaces through which they can interact with other connectors or SCM modules 135. The network interface can include an exposed web-based API that allows the other members of system 100 to send commands or data to connectors 115. The web-based API can be advantageously based on HTTP, XML, SOAP, WSDL, SQL, or other known protocols. In such embodiments, one should appreciate connectors 115 can be consider to operate both as a web client or a web server, especially in a peer-to-peer fashion Connectors 115 can provide the web functionality to their respective peers 110 or leverage existing web capabilities within a computing systems of peers 110. One or more of connectors 115 can be installed on the peer's computing system as desired.

One should keep in mind that peers can be small, independent entities that might or might not make themselves known to other members in system 100. Therefore, system 100 is preferably robust against the dynamic nature of a peer's presence to support a transaction. Furthermore, peers in system 100 are note necessarily be visible to all other peers. Visibility or accessibility of peers within system 100 can be managed through registry server 160. Registry server 160 can provide discovery services to connectors 115 so that they can discover each other, or otherwise provide an indication of the presence in system 100, or ability to participate in a transaction relationship.

### Connector Registry Server

In a preferred embodiment, SCM system comprises registry server 160, which can be configured to store registration information relating to connectors 115. As peers 110 participate in a transaction relationship, connectors 115 can contact registry server 160 to obtain information about other connectors 115 that might be required to establish a transaction relationship to fulfill a transaction. The registration information can be used by one of the connectors 115 to discover or to contact other connectors 115. The registration information can also information about which of SCM modules 135 can be accessed by connectors 115 in support of establishing a desired transaction relationship.

Registry server 160 can comprise a database or other data store that is network accessible over network 150. The registration information of a connector 115 can take on a wide variety of types that can be brought to bear in support of establishing an SCM transaction relationship. Contemplated registration information about a connector 115 can include a name possibly in a namespace, a connector identifier (e.g., GUID, UUID, etc), a network address (e.g., IP address, URL, domain name, etc.), group membership, group transaction member information, a group identifier, access levels, permissions, attributes, version information, or other information relating to connector 115.

One type of registration information can also include a connector's available relationships in which it can participate. The available relationships represent a quantified description of possible ways in which a connector 115 can relate to other connectors 115 with respect to possible transactions. The available relationship information can include connector's role (e.g., vendor, retailer, supplier, distributor, data supplier, SCM module support, etc.) with respect to different transaction relationships.

When a connector 115 is active, it can remain registered with registry server 160 so that SCM modules 135 or other connectors 115 can find or discover connector 115. When connector 115 is inactive or not connected, registry server 160 can un-register the connector. Server 160 can determine if connector 115 should be unregistered using various suitable methods. For example, server 160 can poll connector 115 to determine if connector 115 should remain listed as an active connector. Another example includes connector 115 supplying a heartbeat to server 160 to signal it state: active, passive, present, not present, on, off, or other state. When a connector becomes active again, it can simply register again with registry server 160 by notifying server 160 of connector's 115 availability.

The risk of losing a connected connector 115 in an established transaction relationship can be mitigated through various methods. One acceptable method for mitigating the risk of losing the coherency of a relationship can include having connectors 115 provide a level of commitment to the relationship through registry server 160. The commitment could include an amount of time, number of transactions, or other level of commitment to which a connector 115 is able to guarantee.

### Transaction Relationships

One should appreciate the distinctions among relationships, roles, and transactions. A relationship can be considered a group of peers 110 that could work together toward a common transaction goal, where the members of the group can be linked to each other through their respective connectors 115. The types of relationships that can available to a connector 115 can be mapped to one or more applications, but the relationships do not necessarily have a one-to-one mapping to an application. Transaction relationships can be quite varied within an SCM ecosystem 100. In some embodiments a transaction relationship can be characterized by a role or transaction objective.

A role of a connector 115 can be considered a representation of an objective of the connector 115 in the relationship. Note should be taken that a connector 115 could play different roles within the same type of transaction relationship. For example, a small retailer could take on a retailer role in a VMI transaction relationships with respect to a large supplier, and then could take on the role of supplier in another VMI transaction relationship with respect to a another retailer. Different types of roles are contemplated including active roles in the relationship (e.g., retailer, vendor, supplier, distributor, service provider, etc.), or support roles that provide some sort of support. Support roles can include data sharer, data store, processor running one or more of SCM modules 135, a proxy, a group coordinator, or other roles that are not directly related to the transaction but rather provide infrastructural support.

A transaction can be considered to represent an exchange of retail data to achieve a common goal among members of the transaction relationship. In some embodiments, the transaction includes an SCM application applied to retail data exchanged among connectors 115 or SCM modules 135. Thus, the relationships, roles, or transactions can be considered distinct concepts.

A relationship is considered a quantified description of how peers can relate to each other. A relationship can include two, three, or more peers with respect to a transaction. Again, one should note a single peer could participate in many different possible relationships, serially or in parallel. Furthermore, a relationship can include one or more roles that one or more peers might take on within the relationship as represented by the peer's connector 115.

Peers 110 can participate in one or more relationships. In some embodiments, peers 110 include a single connector 115 that provides support for multiple relationships. It is also contemplated that multiple connectors 115 could be deployed on a peer's computer systems to support multiple relationships. Furthermore, connector 115 can be configured to participate in multiple transaction relationships in parallel where connector 115 takes on a homogeneous set of roles or even a heterogeneous mix of roles among the multiple relationships.

An example is likely in order to provide additional clarity with respect to the distinct concepts of relationships, roles, or transactions. Consider an ecosystem 100 where peers 110 represent a buyer's group (e.g., group 120) that pull together to increase their leverage for purchasing products from a supplier (e.g., supplier peers 110N or 110X). Each member of group 120 has a role of a retailer as represented by their connecters 115. At a later date, one of the retailers could switch roles from being a retailer to a distributor with respect to other members of group 120, should they require access to additional products that the first retailer might have as overstock. One should appreciate that the roles that a connector 115 can take on in a transaction relationship could change dynamically over time as transactions are conducted. Furthermore, a connector 115 could have multiple roles within a single transaction relationship. For example, in the previous example, a connector 115 could present itself as a retailer member in group 120 with respect to the suppliers, and the connector 115 could at the same time present itself as a distributor for buyer's group 120.

### Peer Group of Connectors

In some embodiments connectors 115 can form one or more groups 120 of connectors 115, possibly identified with a group identifier, name, or other type so moniker. Group 120 can reflect a common goal among peers 110, possibly as members of SCM ecosystem 100. As mentioned earlier group 120 could be formed to represent a buyer's group of many small retailers to leverage buying power with respect to a large supplier. Other possible groups 120 can include a distributor group, a supplier group, a service provider group, or other types of group. It is also contemplated that members of the group could have different or heterogeneous roles to form an ecosystem among them, possibly based on vendor management inventory or customer relationship management applications.

In embodiments supporting groups, it is contemplated that one or more of connectors 115 could operate as a group leader 125 through which other connectors 115 in group 120 can discover each other. For example, registration information for group 120 could be stored in association with one of connectors 115 operating as group leader 125. As connectors 115 enter ecosystem 100, rather than contacting SCM service 130, the connectors could contact group leader 125. Such approaches would likely be most advantageous in ecosystems operating as VMI or other type of application where there would be a peer 110 that naturally operates as a head of the group 120 with respect to the application. In this sense, connectors 115 could discover each other through the group leader. One should note that leader 125 can offer services similar to registry server 160 with respect to group 120. It is contemplated that connectors 115 in group 120 might discover each other through group leader 125, registry server 160, or both. For example, connector 115C might first contact registry server 160 to discover group 120, then contact group leader 125 to discover other members of the group 120.

One should note that connectors 115 can be mutually discoverable without requiring registry server 160. In some embodiments, connectors 115 could send out a broadcast, direct casts, multi-cast, or other type of discovery request. In response, other connectors 115 on network 150 can respond. Additionally, connectors 115 could utilize group leader 125 to discover other connectors 115.

### Requesting a Transaction Relationship

When a peer, peer 110A for example, wishes to conduct a transaction, connector 115A can contact registry server 160 with relationship request information relating to the desired transaction relationship or relating to connector 115. Example information can include a role, a connector ID, a transaction identifier, a relationship identifier, or other information useful to define a transaction relationship. In response, registry server 160 can use the relationship request information to identify other registered connectors having complementary registration information that supports the requested transaction relationship. In this sense a first connector can discover other connectors via registry server 160. Other forms of discovery are also contemplated as discussed further below.

In some embodiments, the requested transaction relationship among connectors 115 could be defined a priori to the request. In other embodiments, especially in an environment where peers 110 are unaffiliated, independent, or transitory, the requested transaction relationship among the connectors could require instantiation. The requested transaction relationship can be established among connectors 115 based on the available relationships of connectors 115 stored in registry server 160.

### Transaction Stack

In a preferred embodiment, SCM service 130 also uses the registration information, including available transaction relationships and the requested transaction relationship to prepare, establish, instantiate, or otherwise provide access to SCM modules 135 to fulfill the transaction for the relationship. SCM service 130 can correlate the parameters of the requested transaction relationship to similar parameters of those relationships available to connectors 115. SCM service 130 can attempt to construct the requested transaction relationship based on matching, or near matching, of the parameters (e.g., roles, IDs, permissions, access levels, etc.).

Additionally, SCM service 130 also arranges modules 135 to provide functionality that operates on retail data in support of the transaction encapsulated within the requested transaction relation. As the retail data is exchanged from one connector 115 to another, the retail data can pass through or be operated on by modules 135. Modules 135 can be arranged in a monolithic structure, a hierarchical structure, a namespace structure, peer-to-peer structure, a hybrid of structures, or other structure to form a transaction stack based on the requested transaction relationship or available transaction relationships for connectors 115.

In some embodiments, an SCM service 130 has a plurality of SCM modules 135 available, to which connectors 115 have access subject to permissions, authentication, paid fees, or other restrictions. SCM service 130 can arrange such modules together by directing modules 135 to expose their API's to each other, or to connectors 115, in support of the requested transaction relationship. Furthermore, SCM service 130 can also direct connectors 115 to access modules 135 other connectors 115 by having the connectors 115 expose their APIs. Modules 135 can be arranged according to templates, a priori defined applications, per a request from connectors 115, or other rules. SCM modules 135 can communicate with each other directly, possibly on a common server or over network 150 via a suitable protocol exchange (e.g., web service, HTTP, SSL, SSH, TCP/IP, etc.). Especially contemplated transaction relationships include those supporting VMI, CRM, fulfillment, replenishment, or other SCM related applications.

Connectors 115 can communicate with each other directly or indirectly. An example direct communication includes a peer-to-peer communication where at least some of connectors 115 communicate directly with others of connectors 115 in a peer-to-peer fashion. In other embodiment, connectors 115 can communicate with each other through SCM modules 135, possibly operating on a remote computer system or server. It also contemplated that connectors 115 or modules 135 can communication amongst each other through one or more proxies. For example, registry server 160 or group leader 125 could operate as a proxy for communication. Use of proxies is thought to reduce communication overhead when the number of connectors 115 in a transaction relationship is large.

SCM service 130 allows connectors 115 to access one or more of SCM modules 135 arranged to fulfill a transaction among connectors 115 and according to a requested transaction relationship. As previously discussed, modules 135 can be combined using suitable approaches including directing a first module 135 to access APIs of a second module 135. In a preferred embodiment, SCM service 130 configured modules 135 to operate on the retail data of the transaction according to the requested transaction relationship. The use of modules 135 can be restricted based on one or more access levels as discussed below.

The retail data can be exchanged among connectors 115 participating in the transaction relation ship using common transaction format. In more preferred embodiments, the common transaction formation conforms to or is at least based on an industry sanction data format used to transport information relating to goods, services, or other retail data ad discussed above. Connectors 115 preferably can convert retail data from a first format, possibly a proprietary format local to a peer 110, to a second common format. Contemplated formats include those supporting serialized data structure transport based on XML.

### SCM Service

One should note that SCM service 130 could be hosted in a myriad of different fashions while falling within the scope of the inventive subject matter. In some embodiments, SCM service 130 can be a server providing an execution platform for SCM modules 135, or possibly registry server 160. It is also contemplated, that SCM service 130 could be run within virtual machines hosted by an ISP or possibly within a cloud computing infrastructure. Yet another possible embodiment includes connectors 115 hosting SCM modules 135 on computing infrastructure operated by peers 110.

In a preferred embodiment SCM service 130 comprises a for fee service. Clientele can pay a fee in exchange for SCM service 130 providing access to SCM modules 135, registry server 160, or other connectors 115. Fees could include a per-transaction fee, a license fee, a fee associated with available relationships, a fee based on roles, a subscription fee, an application fee, or other types of fees.

### Access Levels

The available transaction relationships in which connectors 115 can participate can be managed according to one or more access levels. Access levels can also be stored within registry server 160. Contemplated access levels include permission levels, registration levels, data hosting levels, or other types of restrictions that could be applied to connector 115 or even to SCM modules 135.

Registration levels represent a restriction based on one, two, three, four, five, or more levels that indicate the extent to which access is granted to SCM functionality provided by SCM service 130. In a preferred embodiment, a peer 110 would be allowed to purchase access to multiple registration levels to ensure that their connector 115 can participate in desired transaction relationships. For example, connector 115 could have sufficient permission to participate in relationships as a retailer and a distributor, but might not have sufficient permission to be a supplier in a transaction relationship.

Hosting levels represent the extent to which a connector 115 provides access to information stored in its database 113. In some embodiments, hosting levels could represent a sharing level, possible including private, protected, or public level. For example, private could be used to keep data tagged as private secured from all others. Protected could be used to share data tagged as protected with others having authorization (e.g., a group members, a supplier, etc.). Public could be used to share data tagged as public with little or no restriction. It is also contemplated that hosting level could also include a presentation level indicating how data is to be presented to other members of system 100. For example data could be presented as raw data in the common transaction format, via a web service API, a web page, or a human readable report.

An astute reader will appreciate that connectors 115 could have different rights to access SCM modules 135 or its corresponding application stack depending on access levels associated with a role of connector 115. For example, a connector 115 could be permitted to communicate with a specific SCM module 135 while participating as a retailer. However, connector 115 might not have rights to communicate with the same SCM module 135 as a supplier, even though the connector 115 is still operating within the same type of requested transaction relationship.

### SCM System Configurations

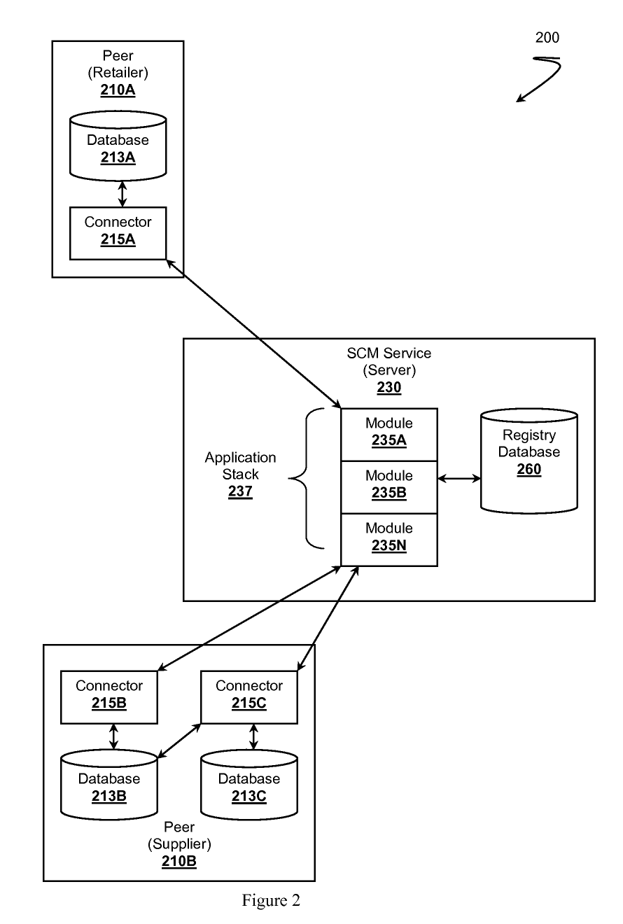

FIG. 2 illustrates various possible aspects of an SCM system. SCM system 200 includes SCM service 230 hosted on a remote server accessible over a network by peers 210A or 210B. In the example shown, application stack 237 comprising one or more of modules 235A, 235B, through 235N, also resides on server 230. Furthermore, it is contemplated server 230 can also host registry database 260 that can be accessed by connectors 215A, 215B or 215B.

It is also contemplated that a peer 210 can comprise multiple connectors or databases. For example, peer 210B includes connectors 215A and 215B, or can include database 213A or 213B. Furthermore, it is contemplated that a single connector could provide access to more than one database as illustrated with connector 215C and databases 213B and 213C.

FIG. 3 also presents other possible configurations of an SCM system. SCM system 300 can provide access to an application stack constructed from modules 335A, 335B, through 335N, where modules 335 can be hosted by connectors 315A and 315B. As discussed above, modules 335 can communicate with each other over network 350 via web services. It should be appreciated that connectors 315A and 315B can operate as a web client and a web server in such an embodiment.

### Analysis Engine

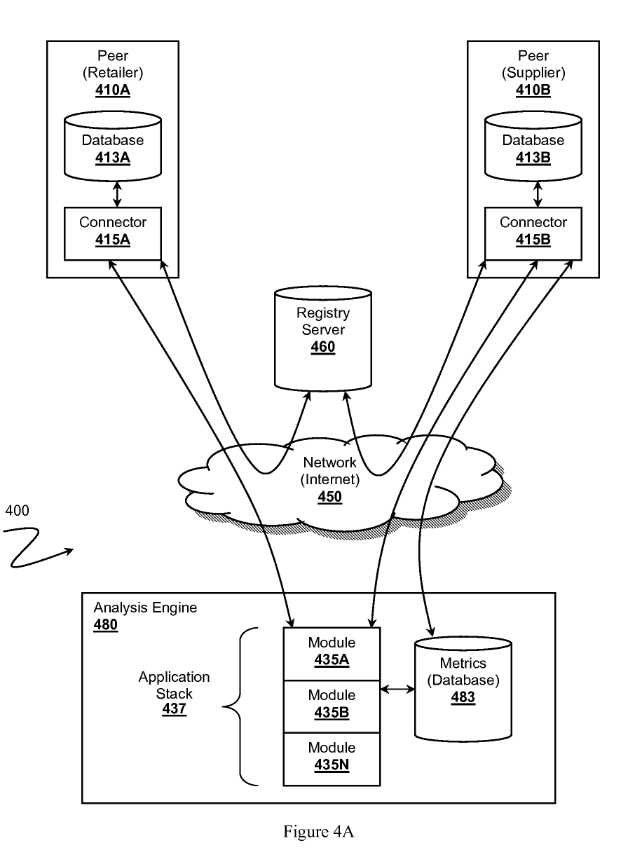

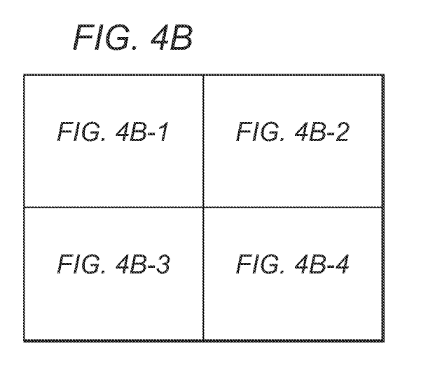

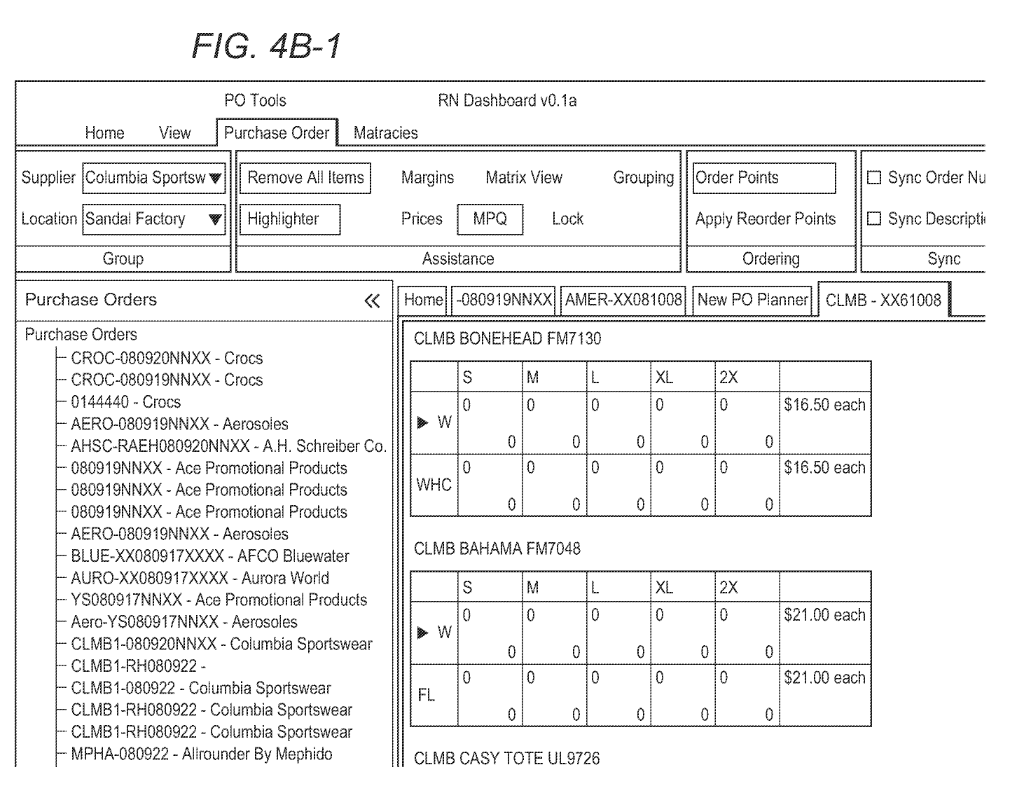

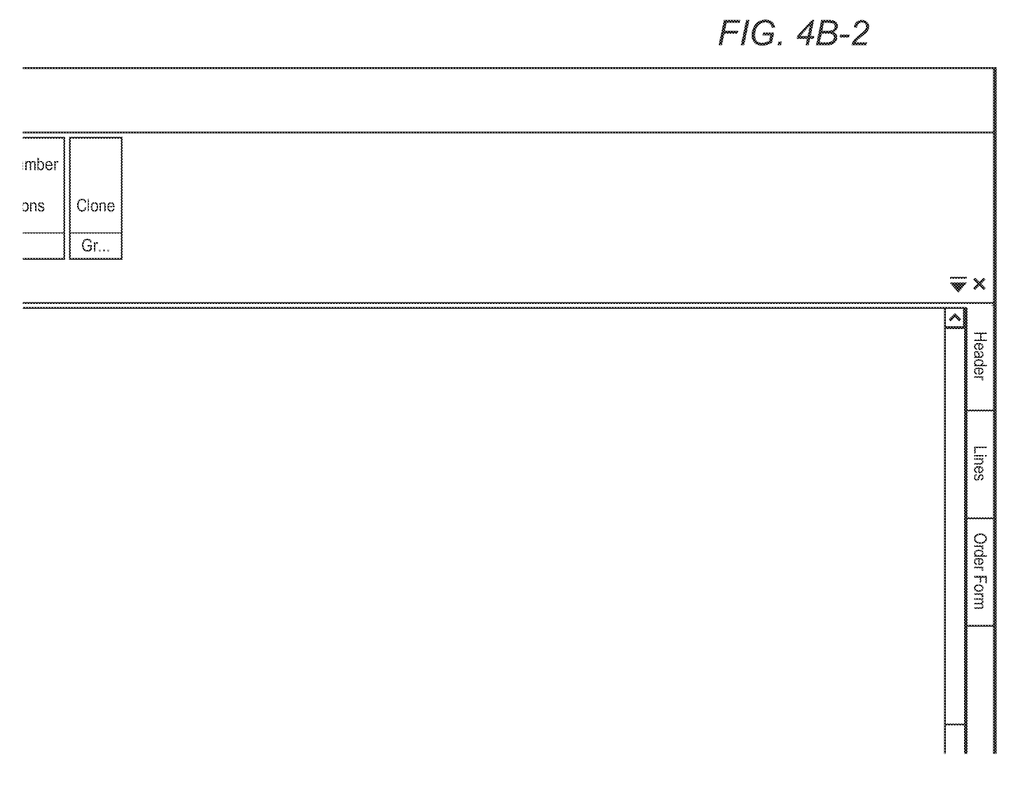

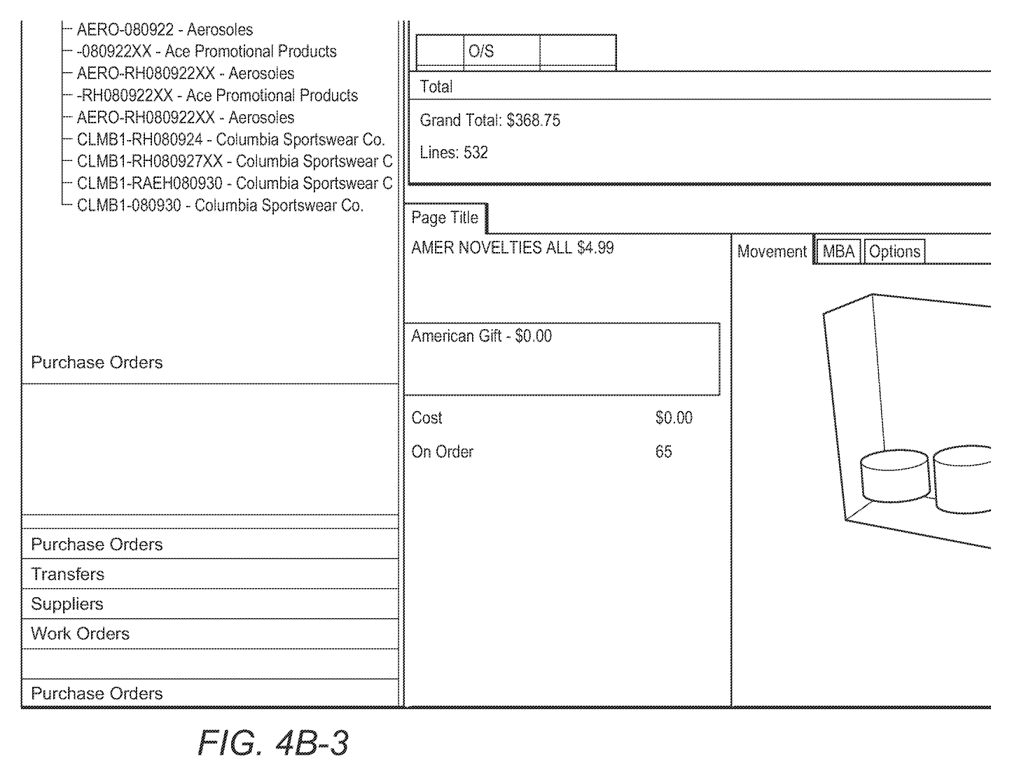

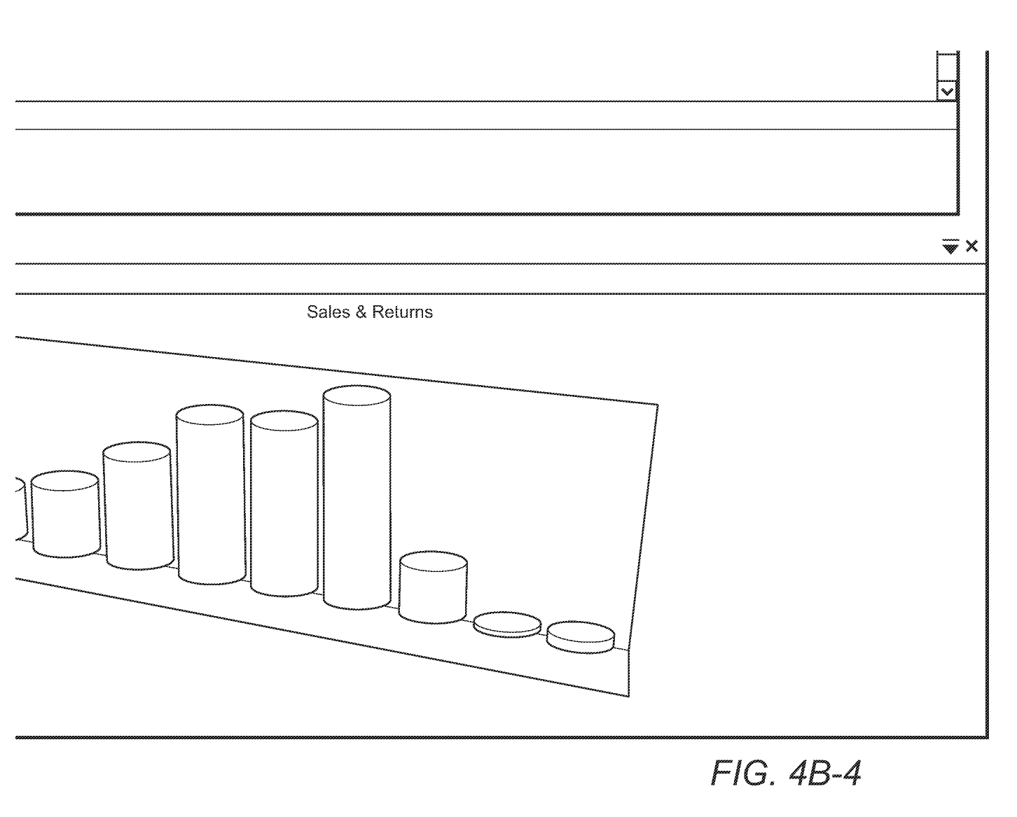

In FIG. 4A, SCM system 400 illustrates that an SCM ecosystem can also include analysis engine 480. Analysis engine 480 can monitor various aspect of system 400. For example, engine 480 can monitor or track access to application stack 437, activity of peers 410A or 410B, accumulate metrics 483, or other data relating to a transaction conducted according to a requested transaction relationship. In some embodiments, as shown, analysis engine 480 can operate on a server and host application stack 437. It is contemplated that engine 480 could also be local to or distributed among connectors 415.

It a preferred embodiment, analysis engine 480 can also construct one or more reports having data relating to the accumulated metrics 483. For example, FIG. 4B presents a dashboard showing various data relating to a retailer participating in an SCM ecosystem. The dashboard presented in FIG. 4B is provided of illustrative purposes and could include a wide variety of metric information.

### Providing an SCM System

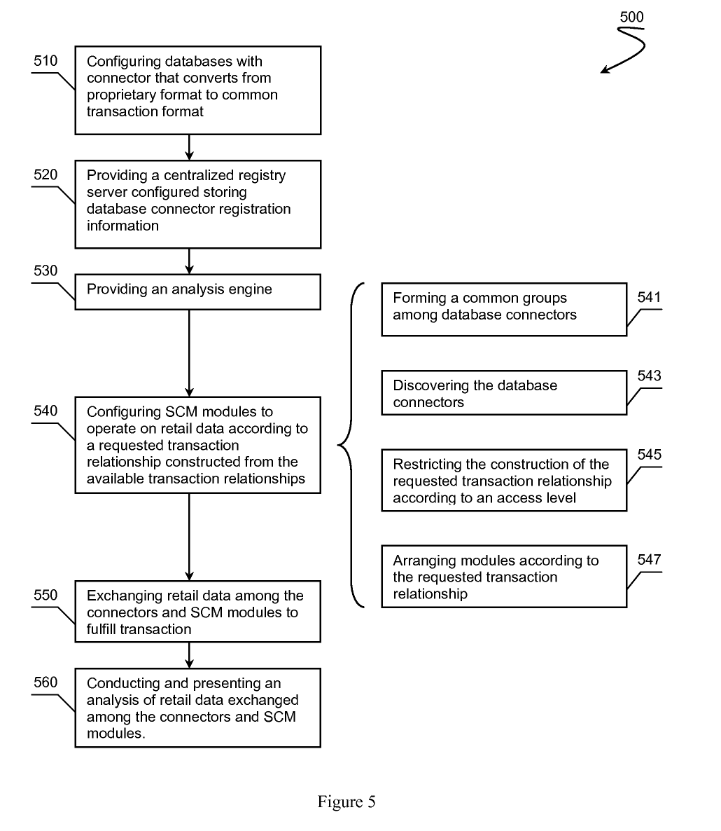

FIG. 5 presents an overview of method 500 for providing an SCM system of independent trading partners, and also provides additional details with respect to various concepts previously presented. One should note that the steps of method 500 do not necessarily have to be conducted in the order presented.

Step 510 can include configuring one or more databases with a database connector. Preferably the database connector is configured to convert from a trading partner's retail data format, possibly a proprietary format, to a common transaction format. In some embodiments, the database connector can be installed as software stored on a computer readable media, where the software configures a processor to convert retail data as desired or necessary in support of a requested transaction relationship. It is also contemplated that the database connector could comprises a physical computing device installed at a trading partner's facility, where the connector provides an interface exposed to a network that is accessible by other trading partners (e.g., Internet), and an interface to the retailer's database. In some embodiments, the connector could host the trading partner's database.

Step 520 can include providing a registry server configured to store registry information associated with the database connector. In preferred embodiments, the registry information can include, among other information, one or more available transaction relationships in which a connector can participate. The available transaction relationships can be characterized by roles, transactions, or other connector related information.

Step 530 can include providing access to an analysis engine configured to monitor or track activity among connectors in the SCM ecosystem. Various metrics can be tracked and stored for later retrieval or analysis. The analysis engine can aid trading partners within the SCM ecosystem to determine if their goals or objectives are being met by the system. For example, a trading partner peer could use the analysis engine for various purposes including tracking trends, monitoring sales performance, tracking invoices, tracking purchase orders, customer support, or other activities.

Step 540 can include configuring one or more SCM modules to operate on retail data according to a requested transaction relationship. For example, a trading partner peer could request that a transaction relation be constructed in support of a VMI application. The database connector of the trading partner can contact the registry server to discover other connectors (e.g., step 543) capable of participating in the requested transaction relationship. The system can construct a requested transaction relationship among the connectors based on the available transaction relationships available to the connectors. One should note that the constructed transaction relationship might not necessary exactly match the requested transaction relationship.

In some embodiments, step 541 can include forming groups among database connectors in support of a transaction. The groups can comprise connectors that have common roles, or different roles. Example groups include a buyer's group, a supplier group, a distributor group, or other types of groups. It is also contemplated the connectors can form groups representing an application including a VMI group, a CRM group, a service provider group, or other group forming an SCM sub-ecosystem.

As previously mentioned, it is contemplated that a requested transaction relationship might not be possible to construct due to one or more restrictions (e.g., hosting levels, permission levels, sharing levels, etc.). For example, step 545 can include restricting the construction of the requested transaction relationship according to one or more access levels associated with the connectors. The access levels could represent permissions levels, hosting or sharing levels, authorization levels, or other types of restrictions. In such embodiments, one or more SCM module might not be available to support a transaction, or one or more other connectors might not be able to take on a desired role within the requested transaction relationship. The contemplated SCM systems can still attempt to provide a constructed transaction relationship that represents a “best fit” for the requested transaction relationship. The best fit transaction relationship might include less preferred connectors, restricted functionality, different SCM modules, different placement of SCM modules (e.g., the module is hosted on a remote server versus hosted on a connector), or other forms of restrictions. It is contemplated that a trading partner peer can be presented with an option to accept or reject such a best fit relationship.

Additionally, step 546 can include arranging SCM modules according to the requested transaction relationship. Arranging SCM modules can include directing the modules to access each others APIs to support a transaction. A module can access another module's API within server using any suitable techniques (e.g., API calls, shared memory, registers, inter-process communications, etc.). It is also contemplated a module can access another module's API over network (e.g., protocol exchange, web services, remote procedure calls, etc.). The latter approach provides a great deal of flexibility in an environment where trading partner peers function as independent entities with respect to each, while also wishing to exchange retail data. Such an approach can be realized by allowing database connectors to host or to provide access to SCM modules as opposed to providing access to SCM modules hosted a centralized remote server.

Step 550 includes exchanging retail data among the trading partner peer's database connectors and the SCM modules to fulfill the transaction supported by the transaction relationship. Preferably the retail data is exchanged using the common transaction format, possibly a transaction formation that conforms to one or more sanctioned industry standards as discussed above.

In embodiment where an analysis engine is available, step 560 can include conducting or presenting an analysis of retail data exchanged among the connectors or SCM modules. The analysis engine can track various metrics associated with the retail data, transactions, transaction relationships, connectors, or other metrics. The trading partners can use the engine to analyze the data to obtain meaningful results for their business.

One aspect of providing an analysis engine in a peer-to-peer SCM ecosystem includes allowing members of the ecosystem to conduct collaborative analyses. For example, rather than a trading partner being able to analyze only their own data, a trading partner could use the analysis engine to conduct analysis across shared data in the system. Such an approach allows one or more trading partners to identify collaborative trends, to generate collaborative foresting, or other types of analysis based on their relationships. Consider a case of a small group of local retailers. The local retailers might share access to their data for analyses without exposing the actual data. The retailers could used the analysis engine to establish trends as a group, or based on other attributes associated with the members of the groups (e.g., location, time, roles in a transaction relationship, etc.)

### Additional Considerations

Although the disclosed subject matter has been presented in view of an SCM system, it is also contemplated that disclosed subject matter can be applied to other types of distributed systems beyond SCM technologies. For example, it is contemplated that one can employ the disclosed techniques to instantiate peer-to-peer applications based on a requested relationship among peers. Such applications could be beneficial other industries including medical systems where sharing of patient data among health care providers can save lives, entertainment content distribution systems, gaming system for instantiating a peer-to-peer game, or still other markets.

SCM systems having trading partner peers that can appear and disappear could result in undesirable behaviors. To mitigate the risk of undesirable behaviors, it is also contemplated that SCM systems include one or more managers that protect the coherency of the various aspects of the system, including groups or transaction relationships. A manager could include a server, SCM module, a registry server, a connector, or other device in the system. One or more managers could take on management roles, responsibilities, or functionality include storing or restoring a transaction relationship's state across loss of connectivity of a connector, retaining connectivity among members of a group, possibly mirroring data of a trading partner, synchronizing data, user management, or other management functions.

SCM systems can also include one or more trading partner interfaces through which the trading partner can configure their experience with the SCM system. Preferred interfaces allow a trading partner to define how their connectors should behave, set access levels, define configurations of relationships or desirable transaction stacks, restore configurations, communicate with other peers via the connectors (e.g., messages, instant messages, Twitter™, email, voice mail, etc.).

Yet another consideration includes providing messaging capabilities for the trending partners, or consumers for that matter. The trading partners can establish one or more criterion that can be used to trigger an alert, event, notification, or other type of message possibly through an analysis engine. When the criteria for the message are met, a corresponding message can be sent to the peer's connector. It is also contemplated that instant messaging (e.g., SMS, MSS, Titter™, chat, social network posts, blog posts, etc.) could be used to present product information to members of the system.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A supply chain management (SCM) system, comprising:
a first trading partner database having a first database connector and a second, different trading partner database having a second database connector, each database connector configured to convert retail data from their respective database formats to a common transaction format; and
an SCM service having:
a registry server storing database connector registration information associated with the first and the second database connectors, the registration information including available transaction relationships for the connectors; and
a plurality of SCM modules configured to operate on the retail data according to a requested transaction relationship constructed from the available transaction relationships, where the retail data is exchanged among the database connectors and SCM modules over a network using the common transaction format while fulfilling a transaction.

2. The system of claim 1, wherein an interaction of at least some of the plurality of SCM modules is configured according to the requested transaction relationship.

3. The system of claim 2, wherein the transaction relationship comprises a vendor managed inventory system.

4. The system of claim 2, wherein the transaction relationship comprises a customer relationship management system.

5. The system of claim 1, wherein the registration information comprises an access level selected from the following access levels: a registration level, and a hosting level.

6. The system of claim 5, wherein the requested transaction relationship is restricted according to the access level.

7. The system of claim 1, wherein the first and the second database connectors are mutually discoverable without requiring the registry server.

8. The system of claim 1, wherein the first database connector and the second database connector exchange the retail data in a peer-to-peer fashion.

9. The system of claim 1, wherein the registration information further includes a group transaction membership.

10. The system of claim 9, wherein the first and the second database connectors are members of a buyer's group.

11. The system of claim 1, further comprising a transaction analysis engine configured to track transaction metrics based on the retail data exchanged between the first and the second database connectors.

12. The system of claim 1, wherein the registry server comprises at least some of the SCM modules.

13. The system of claim 1, further comprising a first trader server other than the registry server comprising at least one of the SCM modules.

14. The system of claim 13, wherein the first trader server comprises the first trader database and its connector.

15. The system of claim 1, wherein the common transaction format comprises an industry sanctioned format.

16. A method of providing a supply chain management (SCM) system, the method comprising:
configuring a first trader partner database and a second trader partner database with a first database connector and a second database connector, respectively, each database connector configured to convert retail data from their respective database formats to a common transaction format;
providing a registry server configured to store database connector registration information associated with the first and the second database connectors, the registration information including available transaction relationships for the connectors;
configuring a plurality of SCM modules to operate on the retail data according to a requested transaction relationship constructed from the available transaction relationships; and
exchanging the retail data in the common transaction format among the database connectors and at least some of the SCM modules over a network while fulfilling a transaction.

17. The method of claim 16, further comprising the first database connector discovering the second database connector without requiring the use of the registry server.

18. The method of claim 16, further comprising arranging an interaction of among at least some of the SCM modules according to the requested transaction relationship.

19. The method of claim 16, further comprising restricting the requested transaction relationship according an access level associated with the first database connector.

20. The method of claim 16, further comprising the first and the second database connector forming a group registered with the registry server.
